(19) United States
(12) Patent Application Publication
(10) Pub. No.: US 2014/0197728 A1
(43) Pub. Date: Jul. 17, 2014

(54) PLASMA DISPLAY PANEL

(71) Applicant: Panasonic Corporation, Osaka (JP)

(72) Inventors: Kazuya Nomoto, Osaka (JP); Yoshito Tanaka, Kyoto (JP); Yuki Kishi, Hyogo (JP); Shiro Ninomiya, Osaka (JP); Toru Nakajima, Osaka (JP); Hidetoshi Hata, Osaka (JP); Kenji Kiriyama, Hyogo (JP); Kentaro Ueda, Osaka (JP)

(73) Assignee: Panasonic Corporation, Osaka (JP)

(21) Appl. No.: 13/976,583

(22) PCT Filed: Jan. 16, 2013
(86) PCT No.: PCT/JP2013/000146

§ 371 Date: Jun. 27, 2013

(30) Foreign Application Priority Data
Jan. 25, 2012 (JP) 2012-012701

(51) Int. Cl. H01J 17/49

(52) U.S. Cl. CPC H01J 17/492
USPC 313/584

(57) ABSTRACT

A plasma display panel includes an effective display region and a non-display region disposed outside the effective display region. A front plate includes sustain electrodes and scan electrodes, over a region corresponding to the effective display region and a region corresponding to the non-display region. Each of the plurality of the sustain electrodes includes a first part, a second part disposed away from the first part, and a third part for electrically coupling the first part with the second part. Moreover, the each of the plurality of the sustain electrodes is such that each of the first part and the second part includes a detached part in the region corresponding to the non-display region. The detached parts included in one of the sustain electrodes are disposed at different positions from each other in an extension direction of the sustain electrodes.

### TECHNICAL FIELD

The technologies disclosed herein relate to plasma display panels for use in such as display devices.

### BACKGROUND ART

A plasma display panel (referred to as PDP, hereinafter) has been known which includes: a front plate in which pluralities of scan electrodes and sustain electrodes are disposed in the row direction, with a discharge gap between each scan electrode and each sustain electrode; a rear plate which is disposed to face the front plate with a discharge space therebetween; and barrier ribs which partition the discharge space into discharge cells (see Patent Literature 1, for example). The scan and sustain electrodes include a first part which faces each other via the discharge gap, a second part which is disposed in parallel with and away from the first part; and third parts which couple the first part with the second part. The widths of the first part and the second part are configured to be smaller than the width of the third parts.

### CITATION LIST

### Patent Literature

Patent Literature 1: Japanese Patent Unexamined Publication No. 2011-159613

### SUMMARY OF THE INVENTION

A PDP disclosed herein includes an effective display region and a non-display region which is disposed outside the effective display region. Moreover, the PDP includes a rear plate and a front plate which is disposed to face the rear plate. The front plate includes sustain electrodes and scan electrodes both disposed over a region corresponding to the effective display region and a region corresponding to the non-display region. Each of the sustain electrodes includes a first part, a second part which is disposed away from the first part, and a third parts which electrically couple the first part with the second part. Moreover, each of the sustain electrodes is such that each of the first part and the second part has a detached part in the region corresponding to the non-display region. Each of the detached parts included in one sustain electrode is disposed at a different position in the extending direction of the sustain electrode.

Another PDP disclosed herein includes an effective display region and a non-display region which is disposed outside the effective display region. Moreover, the PDP includes a rear plate and a front plate which is disposed to face the rear plate. The front plate includes sustain electrodes and scan electrodes both disposed over a region corresponding to the effective display region and a region corresponding to the non-display region. Each of the sustain electrodes includes a first part, a second part which is disposed away from the first part, and a third parts which electrically couple the first part with the second part. Moreover, each of the sustain electrodes is such that each of the first part and the second part has a detached part in the region corresponding to the non-display region. Each of the detached parts included in one of the sustain electrodes and the detached parts in a sustain electrode adjacent to the one of the sustain electrodes are disposed at different positions in an extension direction of the sustain electrodes.

### BRIEF DESCRIPTION OF DRAWINGS

FIG. 1 is a perspective view of a PDP.

FIG. 2 is a schematic cross-sectional view of the PDP.

FIG. 3 is a view of an electrode arrangement of the PDP.

FIG. 4 is a schematic view of a plasma display device.

FIG. 5 is a chart of driving waveforms applied to the PDP.

FIG. 6 is a schematic elevation view of the PDP.

FIG. 7 is an enlarged view of a part of an effective display region of FIG. 6.

FIG. 8 is an enlarged view of a part of FIG. 6.

FIG. 9 is an enlarged view of a part of FIG. 8.

FIG. 10 is a view of a first configuration of non-picture part A.

FIG. 11 is a view of a second configuration of non-picture part A.

FIG. 12 is a view of a third configuration of non-picture part A.

FIG. 13 is a view illustrating regions where reflectance is measured.

FIG. 14 is a graph of a reflectance difference in the first configuration.

FIG. 15 is a graph of a reflectance difference in the second configuration.

FIG. 16 is a graph of a reflectance difference in the third configuration.

FIG. 17 is a view of a fourth configuration of non-picture part A.

FIG. 18 is a view of a fifth configuration of non-picture part A.

### DESCRIPTION OF EMBODIMENTS

Hereinafter, detailed descriptions of embodiments will be made, appropriately with reference to the accompanying drawings. Note, however, that descriptions more detailed than necessary are sometimes omitted. For example, the omitted descriptions sometimes include such as detailed explanations of well-known matters and duplicate explanations of substantially identical configurations. This is made to avoid a redundancy in the descriptions, for easy understanding by those skilled in the art.

Note that the inventors of the present invention provide the accompanying drawings and the following descriptions, for a full understanding of the present disclosure by those skilled in the art. The inventors have no intention to limit the subject matter set forth in the claims to the present disclosure.

### 1. Configuration of PDP 21

PDP 21 includes front plate 1 and rear plate 2. PDP 21 includes discharge space 3 between front plate 1 and rear plate 2 that is disposed to face the front plate.

On front substrate 4 made of glass, front plate 1 includes scan electrodes 5 serving as conductive first electrodes, and sustain electrodes 6 serving as conductive second electrodes. Between scan electrodes 5 and sustain electrodes 6, discharge gaps are disposed. Scan electrodes 5 and sustain electrodes 6 are disposed in parallel with each other. Scan electrodes 5 and sustain electrodes 6 configure display electrodes 7. Display electrodes 7 are disposed on front substrate 4. Display electrodes 7 are covered with dielectric layer 8 composed of a glass material. On dielectric layer 8, protective layer 9 composed of MgO is disposed.

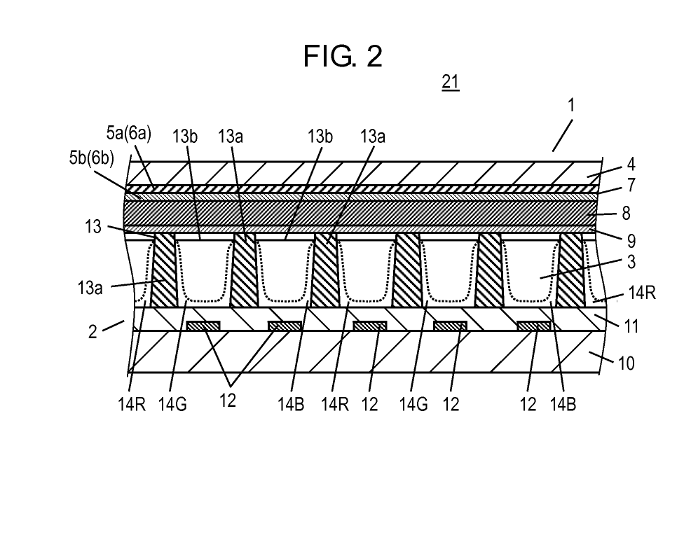

Display electrodes 7 include no transparent electrode such as an ITO (Indium Tin Oxide). Display electrodes 7 are composed of a conductive metal such as silver (Ag), with a layer thickness of a few micron meters. As shown in FIG. 2, scan electrodes 5 and sustain electrodes 6 preferably have at least a double-layered structure (those shown in the figure have double layers). Under-layer electrodes 5a and 6a located in the front substrate 4 side are composed of a material containing a black-color-type metal oxide. Upper-layer electrode 5b and 6b are composed of a white-color-type material with an increased content of Ag so as to exhibit specific resistance smaller than that of under-layer electrodes 5a and 6a. It is configured such that the lightness of under-layer electrodes 5a and 6a is lower than that of upper-layer electrode 5b and 6b. That is, display electrodes 7 are configured to cause the lightness of display electrodes 7 to be low when observed from the display surface in the front substrate 4 side, which allows an omission of a light shielding member between display electrodes 7.

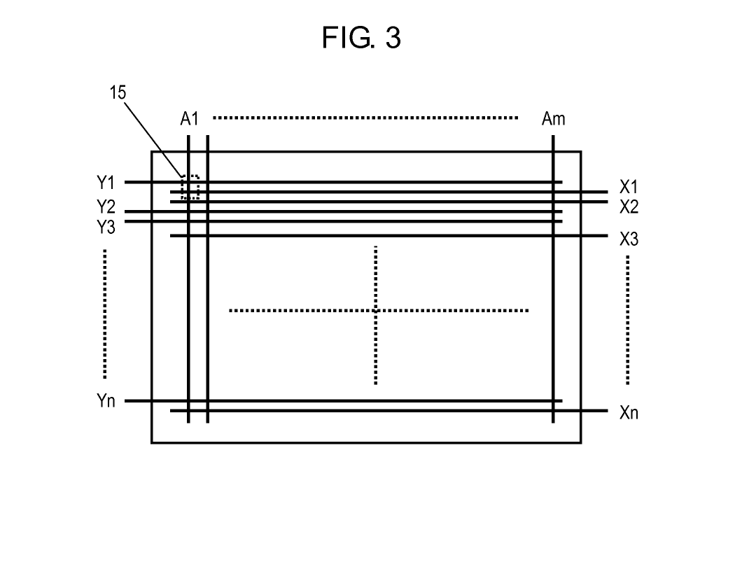

Rear plate 2 includes data electrodes 12 composed of such as Ag, on rear substrate 10 made of glass. The plurality of data electrodes 12 extend in the direction orthogonal to display electrodes 7. Data electrodes 12 are covered with insulator layer 11 composed of a glass material. On insulator layer 11, hanging-rack-shaped barrier ribs 13 composed of a glass material are disposed to partition discharge space 3 into cells 15. Moreover, on the surface of insulator layer 11 and on the side surfaces of barrier ribs 13, there are disposed red phosphor layers 14R for emitting light of red color (R), green phosphor layers 14G for emitting light of green color (G), and blue phosphor layers 14B for emitting light of blue color (B). Cells 15 are disposed at intersecting portions where display electrodes 7 intersect with data electrodes 12, as shown in FIG. 3. Moreover, in discharge space 3, a mixed gas of neon (Ne) and xenon (Xe), for example, is sealed as a discharge gas. Note, however, that the structure of PDP 21 is not limited to that described above. For example, PDP 21 may include barrier ribs having a stripe shape.

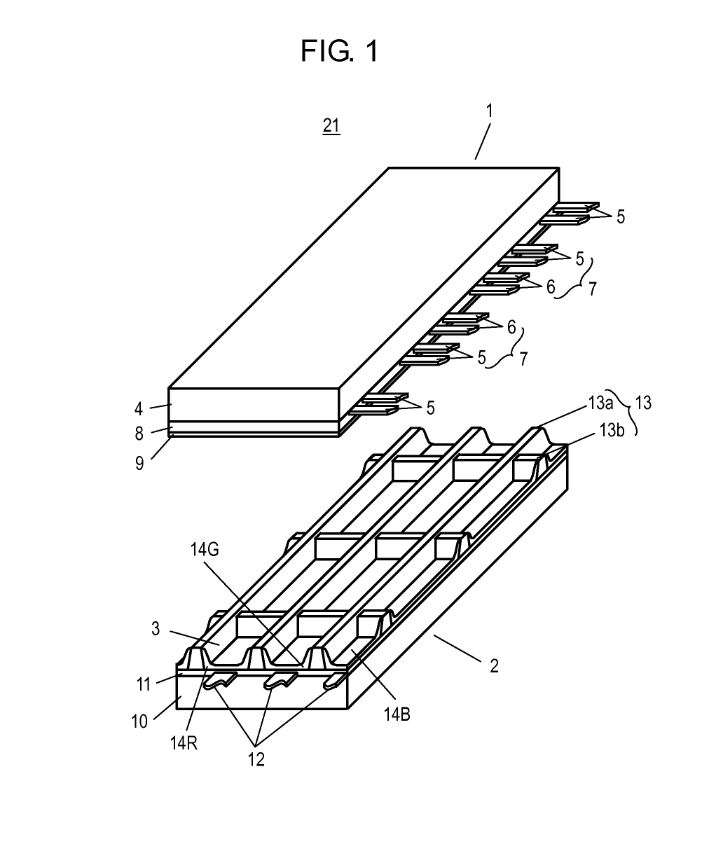

As shown in FIGS. 1 and 2, hanging-rack-shaped barrier ribs 13 are configured with vertical barrier ribs 13a disposed in parallel with data electrodes 12, and horizontal barrier ribs 13b disposed orthogonal to vertical barrier ribs 13a. Blue phosphor layers 14B, red phosphor layers 14R, and green phosphor layers 14G are respectively disposed in a stripe shape along vertical barrier ribs 13a.

Each of scan electrodes 5, sustain electrodes 6, and data electrodes 12 is coupled with respective connection terminals which are disposed at the peripheral portion of PDP 21.

As shown in FIG. 3, PDP 21 includes n-lines of scan electrodes Y1, Y2, Y3 . . . Yn (scan electrodes 5 in FIG. 1), and n-lines of sustain electrodes X1, X2, X3 . . . Xn (sustain electrodes 6 in FIG. 1), with both electrodes extending in the row direction in FIG. 3. Moreover, PDP 21 includes m-lines of data electrodes A1 . . . Am (data electrodes 12 in FIG. 1) that extend in the column direction in FIG. 3. Each one of cells 15 is disposed at a portion where a pair of scan electrode Y1 and sustain electrode X1 intersect with one data electrode A1. Cells 15 are configured such that m×n cells are formed and disposed in the discharge space. Moreover, scan electrode Y1 and sustain electrode X1 are repeatedly arranged in the order of scan electrode Y1-sustain electrode X1-sustain electrode X2-scan electrode Y2 . . . , as shown in FIG. 3.

### 2. Configuration of Plasma Display Device 100

Plasma display device 100 includes PDP 21 configured as shown in FIGS. 1 to 3, image signal processing circuit 22, data electrode drive circuit 23, scan electrode drive circuit 24, sustain electrode drive circuit 25, timing generation circuit 26, and a power supply circuit (not shown). Data electrode drive circuit 23 includes data drivers which are configured with semiconductor devices coupled with one ends of data electrodes 12, for supplying voltage to data electrodes 12.

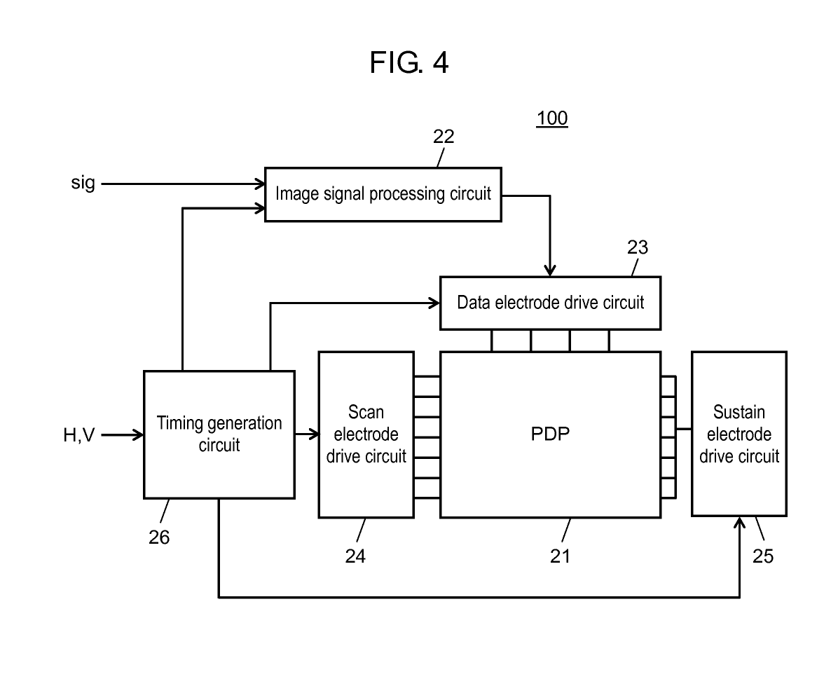

In FIG. 4, image signal processing circuit 22 converts image signal sig into image data for every subfield. Data electrode drive circuit 23 converts the image data for every subfield into the signals corresponding to respective data electrodes A1 to Am, to drive respective data electrodes A1 to Am. Timing generation circuit 26 generates various kinds of timing signals based on horizontal synchronizing signal H and vertical synchronizing signal V, and supplies them to respective drive circuit blocks. Scan electrode drive circuit 24 supplies a driving voltage waveform to scan electrodes Y1 to Yn based on the timing signals, while sustain electrode drive circuit 25 supplies a driving voltage waveform to sustain electrodes X1 to Xn based on the timing signals. Note that the sustain electrodes are commonly coupled with each other at the inside of PDP 21 or the outside of PDP 21 to form a common-connection interconnection which is coupled with sustain electrode drive circuit 25.

### 3. Driving of PDP21

In the embodiment, PDP21 is driven by a subfield driving method. In the subfield driving method, one field is divided into subfields. Each of the subfields includes an initializing period, an address period, and a sustain period.

### 3-1. Initializing Period

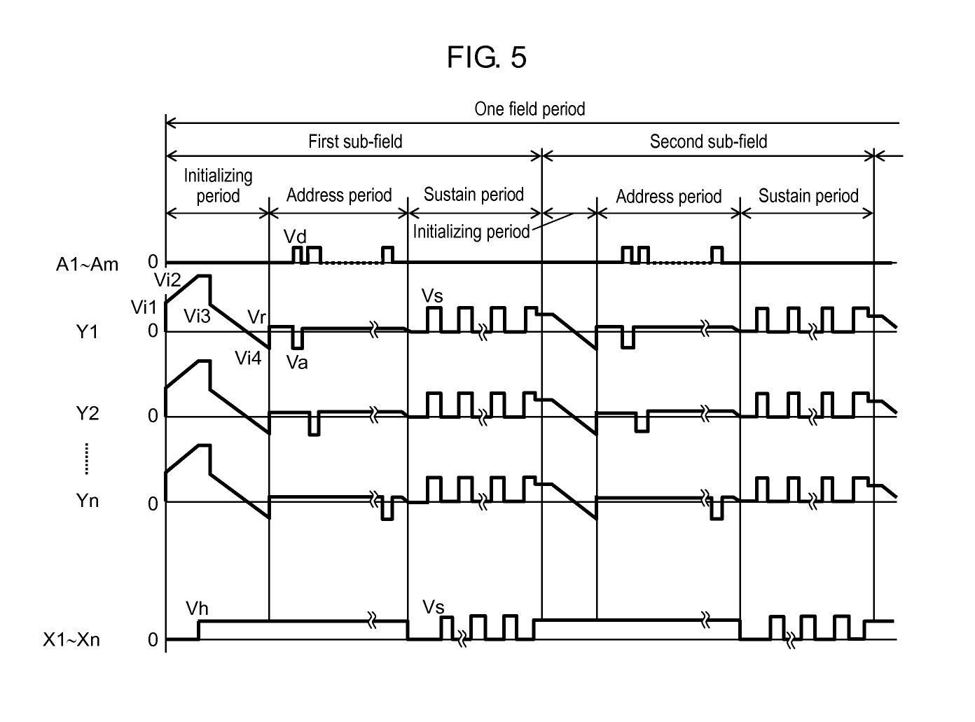

As shown in FIG. 5, in the initializing period of a first subfield, data electrodes A1 to Am and sustain electrodes X1 to Xn are held to be zero (V). To scan electrodes Y1 to Yn, a ramp voltage is applied which gently rises from voltage Vi1 (V) that is equal to a discharge starting voltage or lower up to voltage Vi2 (V) that is higher than the discharge starting voltage. Then, the first round of a weak initializing discharge occurs in all of cells 15. Moreover, a negative wall voltage is stored on scan electrodes Y1 to Yn. A positive wall voltage is stored on sustain electrodes X1 to Xn and data electrodes A1 to Am. The wall voltages are voltages that are generated by wall charges accumulated on constituents, such as dielectric layer 8, which are exposed to discharge space 3.

After that, sustain electrodes X1 to Xn are held to be positive voltage Vh (V). To scan electrodes Y1 to Yn, a ramp voltage is applied which gently falls from voltage Vi3 (V) to voltage Vi4 (V). Then, the second round of the weak initializing discharge occurs in all of cells 15. The wall voltage between on scan electrodes Y1 to Yn and on sustain electrodes X1 to Xn is reduced. The wall voltage on data electrodes A1 to Am is adjusted to be equal to a value appropriate for address operation.

### 3-2. Address Period

In the subsequent address period, scan electrodes Y1 to Yn are temporarily held at Vr (V). Next, a negative scan pulse voltage Va (V) is applied to the first row of scan electrode Y1. At the same time, of data electrodes A1 to Am, data electrode Ak (k=1 to m) of the cell to be lit in the first row is applied with a positive address pulse voltage Vd (V). At this moment, the wall voltage on data electrode Ak and the wall voltage on scan electrode Y1 are added to the externally applied voltage (Vd−Va) (V), which causes the voltage at the intersection between data electrode Ak and scan electrode Y1 to exceed the discharge starting voltage. An address discharge occurs both between data electrode Ak and scan electrode Y1 and between sustain electrode X1 and scan electrode Y1. On scan electrode Y1 of cell 15 where the address discharge has occurred, a positive wall voltage is accumulated. On sustain electrode X1, a negative wall voltage is accumulated. On data electrode Ak, a negative wall voltage is accumulated.

In this way, in cells 15 to be lit in the first row, the address operation is performed in which the address discharges occur to accumulate the wall voltages on the respective electrodes. On the other hand, as for the voltages at the intersections between scan electrode Y1 and data electrodes A1 to Am to which address pulse voltage Vd (V) has not been applied, they do not exceed the discharge starting voltage. Consequently, no address discharge occurs. When the address operation described above is successively performed up to the cells in the n-th row, the address period completes.

### 3-3. Sustain Period

In the subsequent sustain period, scan electrodes Y1 to Yn are applied with positive sustain pulse voltage Vs (V) as a first voltage. Sustain electrodes X1 to Xn are applied with a ground potential equal to zero (V), as a second voltage. At this moment, in cell 15 where the address discharge has occurred, the wall voltage on scan electrode Yi (i=1 to n) and the wall voltage on sustain electrode Xi are added to sustain pulse voltage Vs (V), which causes the voltage between scan electrode Yi and sustain electrode Xi to exceed the discharge starting voltage. Then, a sustain discharge occurs between scan electrode Yi and sustain electrode Xi. The sustain discharge generates ultraviolet rays to cause the excitation of the phosphors. The phosphors under excitation emit light with specific wavelengths. Moreover, on scan electrode Yi, a negative wall voltage is accumulated. On sustain electrode Xi, a positive wall voltage is accumulated. At this moment, on data electrode Ak, a positive wall voltage is accumulated.

In cells 15 where no address discharge has occurred in the address period, no sustain discharge occurs. That is to say, the wall voltages at the point in time of the completion of the initializing period are held. Subsequently, scan electrodes Y1 to Yn are applied with a voltage of zero (V), i.e. the second voltage. Sustain electrodes X1 to Xn are applied with sustain pulse voltage Vs (V), i.e. the first voltage. With this configuration, in cell 15 where the sustain discharge has occurred, the voltage between on sustain electrode Xi and on scan electrode Yi exceeds the discharge starting voltage, which again causes the sustain discharge to occur between sustain electrode Xi and scan electrode Yi. On sustain electrode Xi, a negative wall voltage is accumulated. On scan electrode Yi, a positive wall voltage is accumulated.

### 3-4. Second Subfield and Subsequent Ones

In this manner, subsequently, scan electrodes Y1 to Yn and sustain electrodes X1 to Xn are alternately applied with the sustain pulses corresponding in number to a luminance weight. This causes the sustain discharge to continuously occur in cell 15 where the address discharge has occurred in the address period. In the subsequent subfields, the operations in initializing periods, address periods, and sustain periods are nearly identical to those in the first subfield; therefore, their descriptions are omitted.

### 4. Method for manufacturing PDP

### 4-1. Method for Manufacturing Front Plate

On front substrate 4, scan electrodes 5 and sustain electrodes 6 are formed by a photolithography method. As a material for scan electrodes 5 and sustain electrodes 6, an electrode paste is used which includes silver (Ag), a glass frit for binding the silver, a photosensitive resin, and a solvent. First, the electrode paste is applied to front substrate 4 by such as screen printing. Next, the solvent in the electrode paste is removed with a drying furnace. Then, the electrode paste is subjected to an exposure via a photomask with a predetermined pattern.

Next, the electrode paste is developed to form a display electrode pattern. Finally, the display electrode pattern is fired at a predetermined temperature with a firing furnace. That is, the photosensitive resin in the display electrode pattern is removed. In addition, the glass frit in the electrode pattern melts. After that, the melted glass frit is cooled down to room temperature to turn into a vitrified one. The process described above completes the formation of scan electrodes 5 and sustain electrodes 6.

Here, other than the method in which the electrode paste is applied by screen printing, a sputtering method, an evaporation method, or the like can also be used.

Next, dielectric layer 8 is formed. As a material for dielectric layer 8, a dielectric paste is used which includes a dielectric glass frit, a resin, and a solvent. First, by such as die coating, the dielectric paste is applied on front substrate 4 with a predetermined thickness so as to cover scan electrodes 5 and sustain electrodes 6. Then, the solvent in the dielectric paste is removed with a drying furnace. Finally, the dielectric paste is fired at a predetermined temperature with a firing furnace. That is, the resin in the dielectric paste is removed. In addition, the dielectric glass frit melts. After that, the melted dielectric glass frit is cooled down to room temperature to turn into a vitrified one. The process described above completes the formation of dielectric layer 8. Here, other than the method in which the dielectric paste is applied by die coating, a screen printing method, a spin coating method, or the like can also be used. Moreover, without using the dielectric paste, a layer to be turned into dielectric layer 8 can also be formed by CVD (Chemical Vapor Deposition) or the like.

Next, protective layer 9 is formed on dielectric layer 8.

The processes described above complete the formation of front plate 1 that includes scan electrodes 5, sustain electrodes 6, dielectric layer 8, and protective layer 9 on front substrate 4.

### 4-2. Method for Manufacturing Rear Plate 2

By a photolithography method, data electrodes 12 are formed on rear substrate 10. As a material for data electrodes 12, a data electrode paste is used which includes silver (Ag) for securing electric conductivity, a glass frit for binding the silver, a photosensitive resin, and a solvent. First, the data electrode paste is applied on rear substrate 10 with a predetermined thickness by such as screen printing. Next, the solvent in the data electrode paste is removed with a drying furnace. Then, the data electrode paste is subjected to an exposure via a photomask with a predetermined pattern. Then, the data electrode paste is developed to form a data electrode pattern. Finally, the data electrode pattern is fired at a predetermined temperature with a firing furnace. That is, the photosensitive resin in the data electrode pattern is removed. In addition, the glass frit in the data electrode pattern melts. After that, the melted glass frit is cooled down to room temperature to turn into a vitrified one. The process described above completes data electrodes 12. Here, other than the method in which the data electrode paste is applied by screen printing, a sputtering method, an evaporation method, or the like can also be used.

Next, insulator layer 11 is formed. As a material for insulator layer 11, an insulator paste is used which includes an insulator glass frit, a resin, and a solvent. First, by such as screen printing, the insulator paste is applied with a predetermined thickness on rear substrate 10, on which data electrodes 12 are formed, so as to cover data electrodes 12. Then, the solvent in the insulator paste is removed with a drying furnace. Finally, the insulator paste is fired at a predetermined temperature with a firing furnace. That is, the resin in the insulator paste is removed. In addition, the insulator glass frit melts. After that, the melted insulator glass frit is cooled down to room temperature to turn into a vitrified one. The process described above completes the formation of insulator layer 11. Here, other than the method in which the insulator paste is applied by screen printing, a die coating method, a spin coating method, or the like can also be used. Moreover, without using the insulator paste, a layer to be turned into insulator layer 11 can also be formed by CVD (Chemical Vapor Deposition) or the like.

Next, barrier ribs 13 are formed by a photolithography method. As a material for barrier ribs 13, a barrier rib paste is used which includes a filler, a glass frit for binding the filler, a photosensitive resin, and a solvent. First, the barrier rib paste is applied on insulator layer 11 with a predetermined thickness by such as die coating. Next, the solvent in the barrier rib paste is removed with a drying furnace. Then, the barrier rib paste is subjected to an exposure via a photomask with a predetermined pattern. Then, the barrier rib paste is developed to form a barrier rib pattern. Finally, the barrier rib pattern is fired at a predetermined temperature with a firing furnace. That is, the photosensitive resin in the barrier rib pattern is removed. In addition, the glass frit in the barrier rib pattern melts. After that, the melted glass frit is cooled down to room temperature to turn into a vitrified one. The process described above completes the formation of barrier ribs 13. Here, other than the photolithography method, a sandblasting method or the like can also be used.

Next, phosphor layers 14 are formed. As a material for phosphor layers 14, a phosphor paste is used which includes phosphor particles, a binder, and a solvent. First, by such as a dispenser coating method, the phosphor paste is applied with a predetermined thickness onto insulator layer 11 between adjacent ones of the plurality of barrier ribs 13 and onto the side surfaces of barrier ribs 13. Then, the solvent in the phosphor paste is removed with a drying furnace. Finally, the phosphor paste is fired at a predetermined temperature with a firing furnace. That is, the resin in the phosphor paste is removed. The process described above completes the formation of phosphor layers 14. Here, other than the dispenser coating method, a screen printing method or the like can also be used.

The processes described above complete the formation of rear plate 2 which includes data electrodes 12, insulator layer 11, barrier ribs 13, and phosphor layers 14 on rear substrate 10.

### 4-3. Method for Assembling Front Plate 1 and Rear Plate 2

First, by such as a dispenser coating method, a sealing paste is applied to the circumference of rear plate 2. The sealing paste may include beads, a low melting-point glass material, a binder, and a solvent. The thus-applied sealing paste forms a sealing paste layer (not shown). Then, the solvent in the sealing paste layer is removed with a drying furnace. After that, the sealing paste layer is subjected to a calcination process at a temperature of approximately 350° C. Through the calcination, the resin component or the like in the sealing paste layer is removed. Next, front plate 1 and rear plate 2 are arranged to face each other such that display electrodes 7 are orthogonal to data electrodes 12.

Moreover, front plate 1 and rear plate 2 are held, with peripheral portions of both plates being pressed by each other with such as clips. Being held in this state, the plates are fired at a predetermined temperature to cause the low melting-point glass material to melt. After that, the melted low melting-point glass material is cooled down to room temperature to turn into a vitrified one. This allows front plate 1 and rear plate 2 to be hermetically sealed with each other. Finally, a discharge gas containing such as Ne and Xe is sealed in the discharge space, which completes PDP 21.

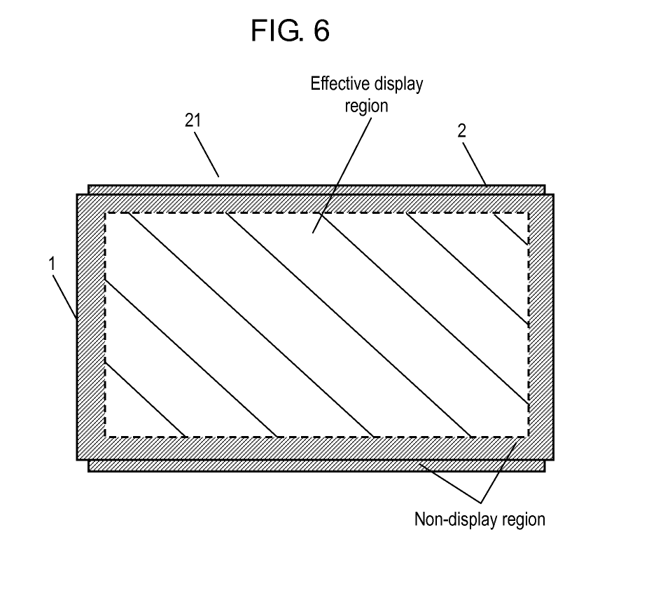

As shown in FIG. 6, PDP 21 includes an effective display region for displaying an image and a non-display region disposed outside the effective display region. The effective display region is a region in which images are displayed. A part of the non-display region is covered with an outer frame part (not shown).

### 5. Detail of Display Electrodes 7

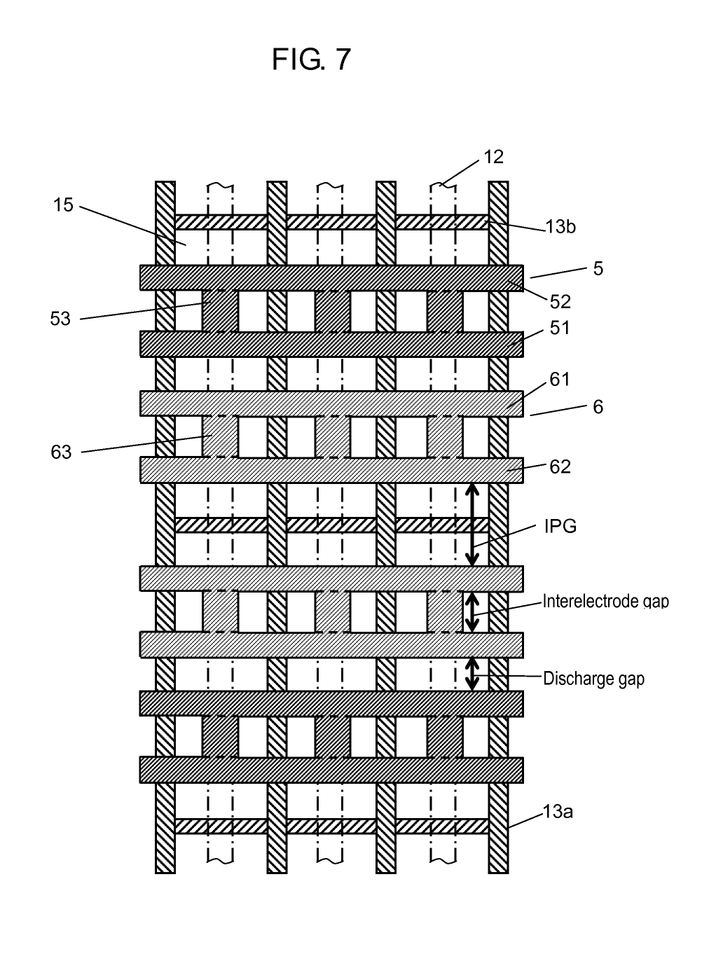

As shown in FIG. 7, each of scan electrodes 5 and sustain electrodes 6 which both configure display electrodes 7 has a ladder shape. Each of scan electrodes 5 includes first part 51 disposed in the discharge gap side, second part 52 disposed in the IPG (Inter Pixel Gap) side, and third parts 53 that couple first part 51 with second part 52. Each of sustain electrodes 6 includes first part 61 disposed in the discharge gap side, second part 62 disposed in the IPG side, and third parts 63 that couple first part 61 with second part 62. First part 51 and first part 61 face each other via the discharge gap. Third parts 53 and 63 are disposed for every cell 15, as an example. Moreover, the discharge gap is 90 μm to 100 μm. The distance between first part 51 and second part 52 is approximately 80 μm, which is configured to be smaller than the adjacent IPGs (approximately 200 μm). The distance between first part 61 and second part 62 is approximately 80 μm as well.

In general, in PDP 21, a glass material with relatively high lightness is used as a material to configure barrier ribs 13. Accordingly, a structure is sometimes employed in which light shielding members are disposed in the IPGs to improve contrast. As in the present embodiment, however, the employment of display electrodes 7 configured to offer low lightness as viewed from the display surface side, makes it possible to improve the contrast without disposing the light shielding members in the IPGs.

### 6. Structure of Display Electrode 7 in Non-Display Region

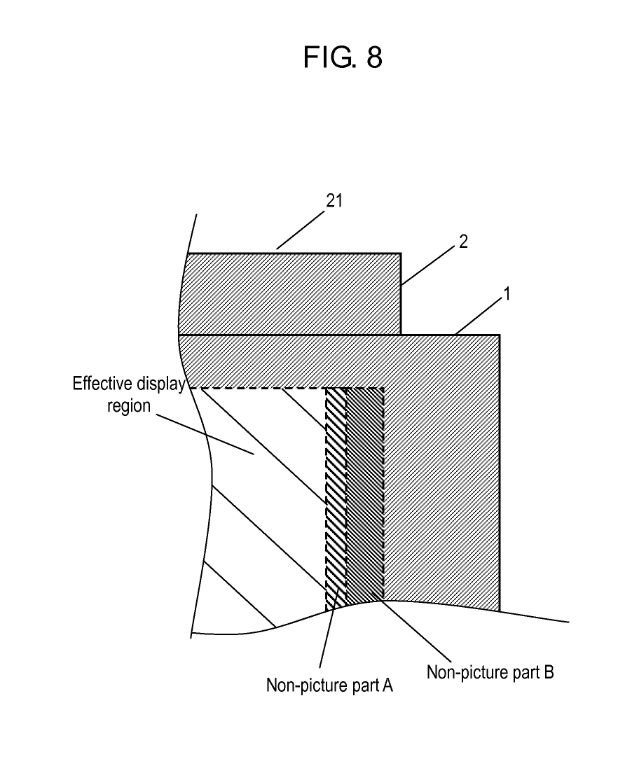

In the present embodiment, as shown in FIG. 8, PDP 21 includes three regions in the area not covered by the outer frame part (not shown): That is, the effective display region, non-picture part A that is a part of the non-display region, and non-picture part B that is a part of the non-display region. Outside the effective display region, non-picture part A is located. Outside non-picture part A, non-picture part B is located. Note that FIG. 8 shows a right side portion of PDP 21 as viewed from the display surface side. In a left side portion of PDP 21, as well as the right side portion, there exist the effective display region, non-picture part A, and non-picture part B.

On the other hand, the non-display region is a region where no image is displayed. That is, both non-picture part A and non-picture part B are regions where no image is displayed.

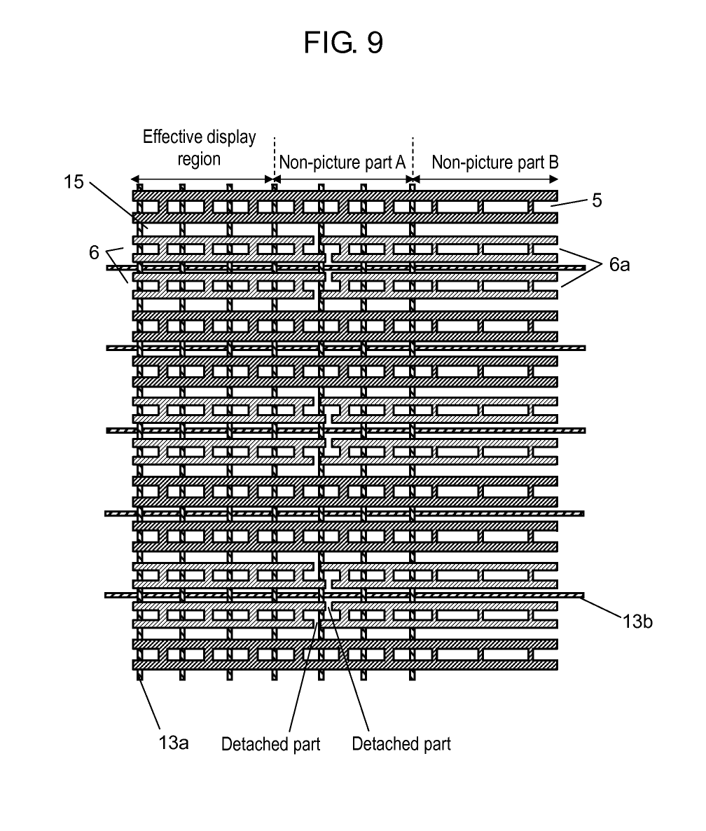

As shown in FIG. 9, in the embodiment, non-picture part A is a non-display region that has cells 15 partitioned by barrier ribs 13. Non-picture part B is a non-display region where no barrier rib 13 is disposed.

There is a configuration in which scan electrodes 5 are led out to a terminal portion, while sustain electrodes 6 terminate within the region of non-picture part A. In this configuration, unlike scan electrodes 5, sustain electrodes 6 are not extended and not led out in the non-display region. In this case, if the outer frame part is disposed in a more outer side of PDP 21, non-picture part A and non-picture part B are sometimes not covered by the outer frame part. That is, non-picture part A and non-picture part B can be visually recognized. Then, the termination portions of sustain electrodes 6 are clearly visually recognized in the display screen. The reflectance differs between the outside and the inside of the termination portions; therefore, there is the case where something strange is felt in the display screen.

In this case, it is preferable that sustain electrodes 6 be extended to non-picture part B so as to have an equivalent electrode structure to that in the effective display region. Unfortunately, the extension of sustain electrodes 6 to non-picture part B sometimes causes erroneous discharges between scan electrodes 5 and sustain electrodes 6.

In PDP 21 according to the embodiment, as shown in FIG. 9, sustain electrodes 6 in the effective display region are configured to be extended to non-picture part A and non-picture part B, and configured to have detached parts in non-picture part A.

That is, sustain electrodes 6 thus-extended beyond the detached parts toward non-picture part B are not electrically connected to sustain electrodes 6 in the effective display region. This means that sustain electrodes 6 have floating sustain electrodes 6a in the termination portions thereof. Floating sustain electrodes 6a are not led out to the edge portion of PDP 21; therefore, termination portions of floating sustain electrodes 6a are disposed in the non-display region.

### 6-1. First Configuration in Non-Picture Part A

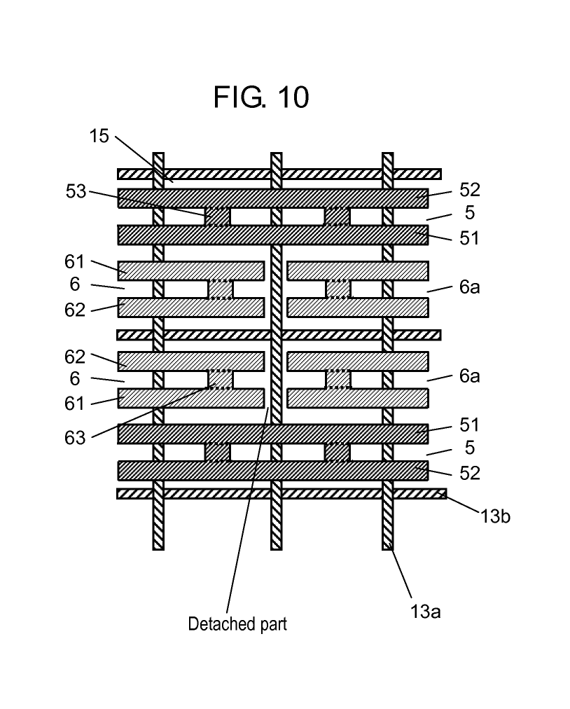

As shown in FIG. 10, in a first configuration in non-picture part A, first part 61 and second part 62 of respective sustain electrodes 6 each have the detached part at the same position in the extension direction of sustain electrodes 6. However, in the first configuration, these detached parts are arranged continuously in the direction perpendicular to the extension direction of sustain electrodes 6. Consequently, the boundary between sustain electrodes 6 and floating sustain electrodes 6a can be clearly visually recognized. Therefore, this possibly reduces the display quality of a display screen image.

### 6-2. Second Configuration in Non-Picture Part A

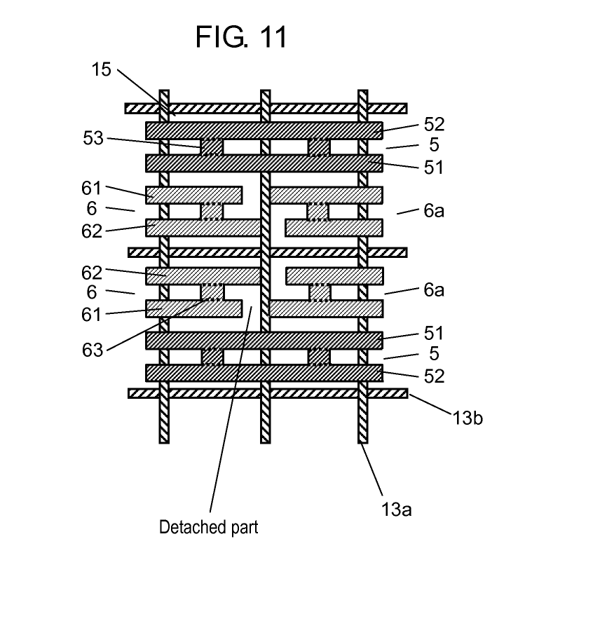

As shown in FIG. 11, in a second configuration, in the non-display region where no image is displayed, the first and second parts of the respective second electrodes each have the detached part. The detached part of one of the first part and the second part is disposed at a position ranging, toward first cell 15, from the location corresponding to barrier rib 13 providing the partition between first cell 15 and second cell 15 at the beginning of the non-display region. The detached part of the other is disposed at another position ranging from the location toward +second cell 15.

In the embodiment, the detached parts are arranged non-continuously in the direction perpendicular to the extension direction of sustain electrodes 6. Accordingly, the boundary between sustain electrodes 6 and floating sustain electrodes 6a becomes hard to be visually recognized.

More specifically, as shown in FIG. 9, in the embodiment, non-picture part A is a region ranging from the center of outermost vertical barrier rib 13a in the effective display region, to the outermost edge portion of vertical barrier rib 13a in the non-display region. Non-picture part B is a region ranging from the end portion of non-picture part A toward the outside. That is, non-picture part B is the region located outside the outermost edge portion of vertical barrier rib 13a in non-picture part A. In the embodiment, non-picture part A includes, as an example, three of cells 15 in the extension direction of sustain electrodes 6.

In non-picture part A, in first to third cells 15 at the beginning of non-picture part A, insulator layer 11 and barrier ribs 13 are disposed on rear substrate 10. In addition, there are disposed three of cells 15 partitioned by barrier ribs 13, red phosphor layer 14R, green phosphor layer 14G, and blue phosphor layer 14B. Then, only in first cell 15 that begins non-picture part A, data electrode 12 (not shown) is disposed.

On the other hand, in non-picture part B, no barrier rib 13 is disposed. Moreover, insulator layer 11 (not shown) is exposed.

As shown in FIGS. 9 and 11, each of sustain electrodes 6 in non-picture part A is such that first part 61 includes the detached part at the position ranging, to the effective display region side, from outer vertical barrier rib 13a, as a center, of the first cell that begins non-picture part A.

That is, the detached part is disposed at the position corresponding to the first cell that begins non-picture part A. Moreover, second part 62 includes the detached part disposed at the position ranging, to the non-picture part B side, from outer vertical barrier rib 13a, as a center, of the first cell that begins non-picture part A. The detached part of second part 62 is formed at the position corresponding to the second cell at the beginning of non-picture part A. This results in a reduction in the occurrence of erroneous discharges in the non-display region.

The distance of the detached part (the length of the region being detached) is preferably not smaller than 90 μm and not larger than 100 μm. That is, the distance is preferably equivalent to the distance of the discharge gap. When the detached part is made shorter, the boundary between sustain electrodes 6 and floating sustain electrodes 6a becomes visually unclear. As a result, it is possible to suppress a feeling of something strange in the display screen.

### 6-3. Third Configuration in Non-Picture Part A

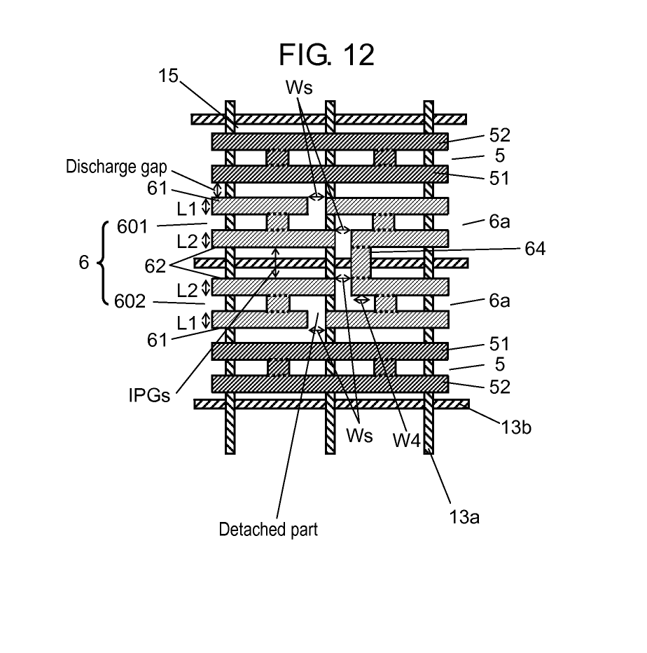

A third configuration is different from the second configuration in that, as shown in FIG. 12, second parts 62 of adjacent sustain electrodes 6 in the IPG are coupled with each other by fourth part 64. That is, second part 62 of first sustain electrode 601 is coupled, by fourth part 64, with second part 62 of second sustain electrode 602 adjacent to first sustain electrode 601. Then, width W4 of fourth part 64 is defined as the following equation (Eq. 1) where the width of first part 61 is L1, the width of second part 62 is L2, the length of the detached part of sustain electrode 6 is Ws, and the distance of the IPG is IPGs.

W4≦2×(L1+L2)×Ws/IPGs [Eq. 1]

That is, the area of fourth part 64 is not larger than the area of the four detached parts of adjacent sustain electrodes 6. When both sides of Eq. 1 are equal to each other, the total area of the four detached parts of adjacent sustain electrodes 6 is equal to the area of fourth part 64. However, when the area of fourth part 64 is equal to the total area of the four detached parts of adjacent sustain electrodes 6, width W4 of fourth part 64 must be larger. That is to say, when watching the display screen of PDP 1, fourth parts 64 are easy to be visually recognized. As a result, something strange is sometimes felt in the display screen.

Consequently, it is preferable that the area of fourth part 64 be equivalent to the total area of the detached parts which are included in second parts 62 or first parts 61 of adjacent sustain electrodes 6. That is, the following Eq. 2 or Eq. 3 holds more preferably.

W4=2×L2×Ws/IPGs [Eq. 2]

W4=2×L1×Ws/IPGs [Eq. 3]

With this configuration, the area of the detached parts is compensated by fourth part 64. This allows the boundary between sustain electrodes 6 and floating sustain electrodes 6a to be visually unclear when watching the display screen of PDP 21. As a result, it is possible to suppress the feeling of something strange in the boundary between the effective display region and the non-display region in the display screen.

### 6-3. Evaluation of Embodiments

Evaluation of the embodiments is carried out using a reflectance difference.

The reflectance difference is a difference between the reflectance of the effective display region and the reflectance of the non-display region. The reflectance is the numeric value of the ratio of the reflected wavelength to the incident wavelength when a wavelength is reflected at a boundary surface between media. The reflectance difference is determined as follows.

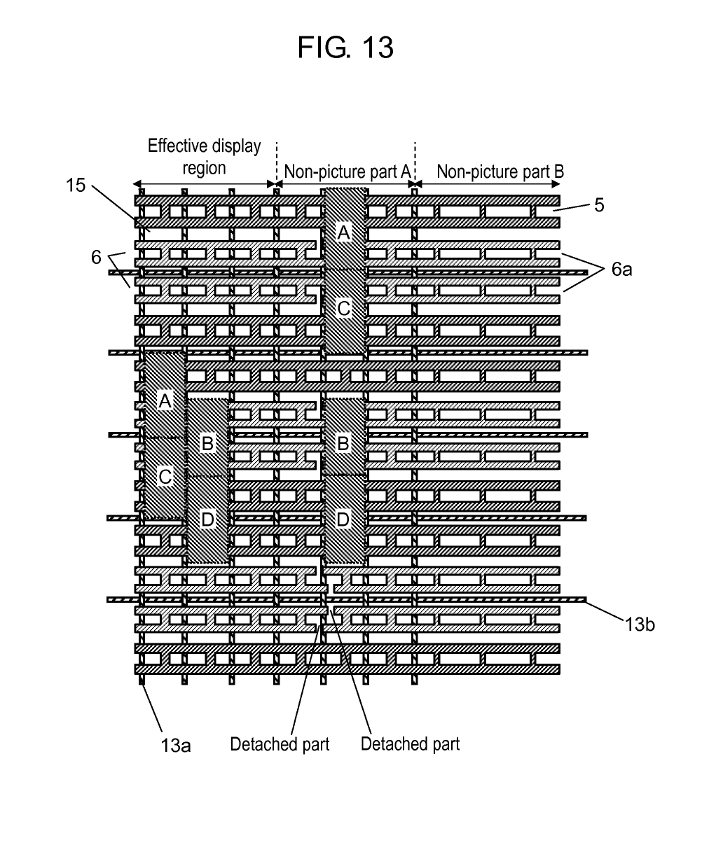

(1) As shown in FIG. 13, the average reflectance of region A corresponding to one cell 15 in the effective display region is measured. Like this, also in non-picture part A, the average reflectance is measured of region A corresponding to one cell 15, located in the outer side, of cells 15 including the detached parts.

(2) The average reflectance in non-picture part A is subtracted from the average reflectance in the effective display region measured in step (1) to determine the reflectance difference.

(3) The measurement region is shifted slightly step by step to the regions (region C, region B, and region D) in the short side direction of PDP 21 (the extension direction of vertical barrier ribs 13a). From the average reflectance of each of the measurement regions, the average reflectance difference is determined.

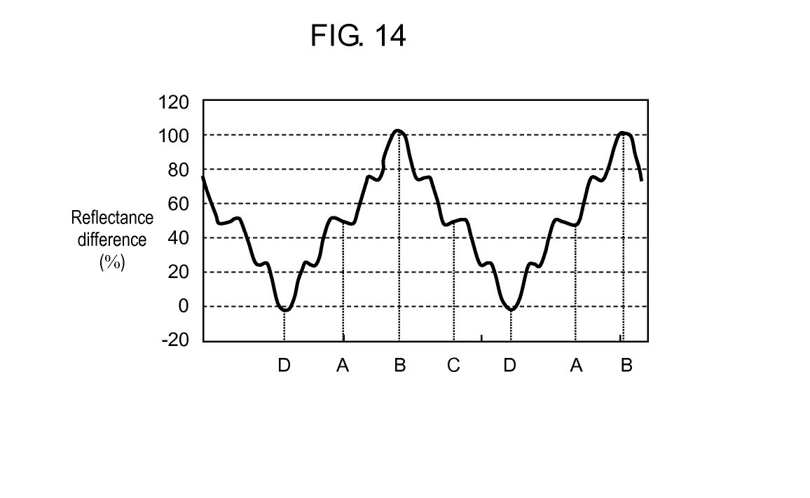

The vertical axes of FIGS. 14 to 16 indicate the average reflectance of the respective regions. Values in the vertical axis of FIG. 14 are the reflectance differences being normalized such that the maximum reflectance difference in the configuration of FIG. 10 is 100%. The horizontal axes indicate the respective regions. For example, A to D shown in FIG. 13 corresponds to A to D in FIG. 14.

As shown in FIGS. 14 to 16, the larger the numeric value of the reflectance difference is, the larger the difference in the average reflectance between the effective display region and non-picture part A is. As the reflectance difference becomes larger, the boundary between the effective display region and non-picture part A becomes easier to be visually recognized when watching the display screen of PDP 21.

For example, all of regions A to D in the effective display region include no detached part. On the other hand, regions A to C in non-picture part A include the detached parts. In particular, region B includes four of the detached parts; therefore, the reflectance difference of the region is the largest among them.

On the other hand, in region D, non-picture part A employs the same electrode structure as that in the effective display region. That is, region D includes no detached part; therefore, the reflectance difference thereof is the smallest among them. Accordingly, in region D, the boundary between the effective display region and the non-display region is hard to be visually recognized.

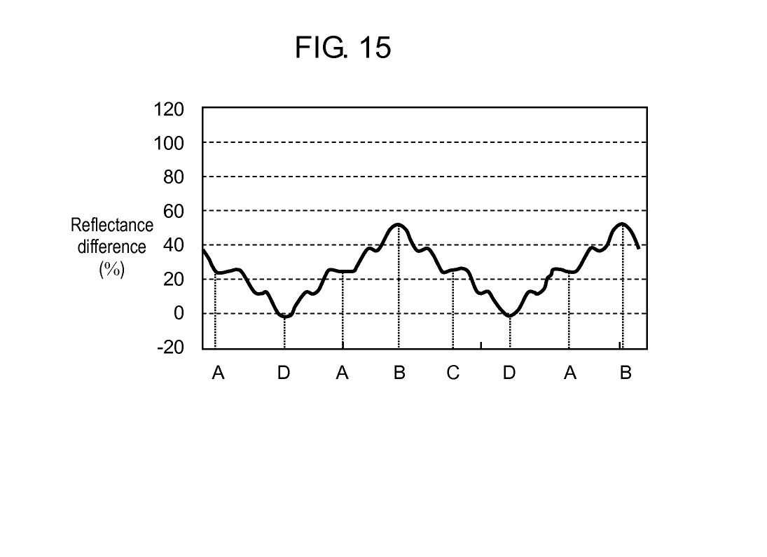

The result of the reflectance difference in the electrode structure of FIG. 11 is shown in FIG. 15. In FIG. 11, the positions of the detached parts of adjacent sustain electrodes 6 are out of each other, to the left and the right, with vertical barrier rib 13a being a boundary between the left and the right. For this reason, the reflectance difference thereof is smaller than that in the electrode structure of FIG. 10. The maximum reflectance difference is approximately 50%. Therefore, the boundary between sustain electrodes 6 and floating sustain electrodes 6a is hard to be visually recognized.

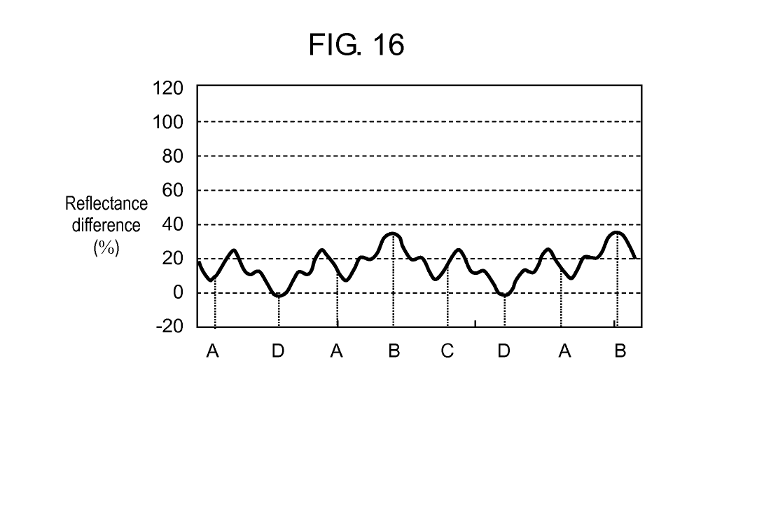

Moreover, the result of the reflectance difference in the electrode structure of FIG. 12 is shown in FIG. 16. The electrode structure of FIG. 12 is such that the positions of the detached parts of adjacent sustain electrodes 6 are out of each other, to the left and the right, with vertical barrier rib 13a being a boundary between the left and the right, and that the structure satisfies Eq. 2 or Eq. 3 described above. Accordingly, the reflectance difference in the electrode structure shown in FIG. 12 is smaller than that in the electrode structure shown in FIG. 11. As shown in FIG. 16, the maximum reflectance difference is approximately 33%. Therefore, the boundary between sustain electrodes 6 and floating sustain electrodes 6a is harder to be visually recognized.

In the present embodiment, the descriptions have been made regarding the effective display region and non-picture part A that are located in the right side of PDP 21 where the terminals of scan electrodes 5 are disposed. However, the descriptions hold true also regarding the effective display region and non-picture part A that are located in the left side of PDP 21 where the terminals of sustain electrodes 6 are disposed. That is, their structures are identical, except only that the correlation between scan electrodes 5 and sustain electrodes 6 is changed. For example, in non-picture part A of the left side portion of PDP 21, the detached parts are disposed in scan electrodes 5. In addition, in non-picture part A and non-picture part B, floating electrodes are disposed which have the same structure as that of scan electrodes 5. With the same structure, also in non-picture part A of the left side portion of PDP 21, the boundary between scan electrodes 5 and the floating electrodes is visually unclear. Consequently, it is possible to reduce the feeling of something strange in the display screen.

### Other Embodiments

The present invention is not limited to the contents described in the aforementioned embodiments. Then, other embodiments will be described.

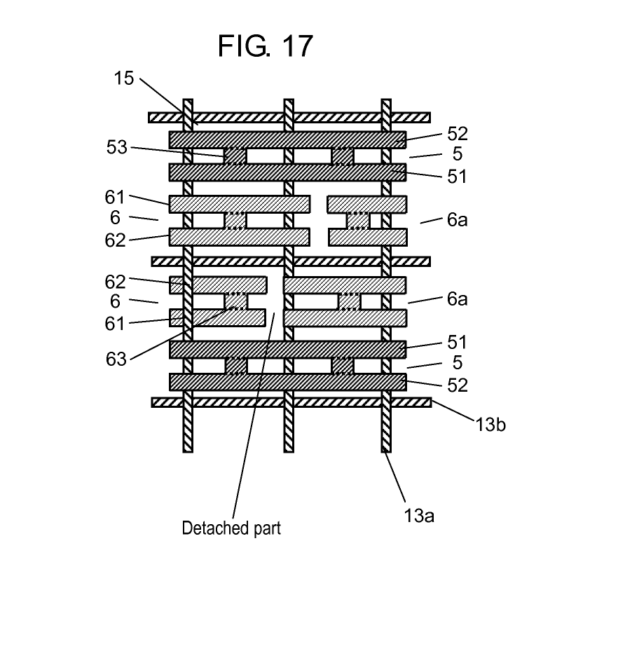

As shown in FIG. 17, as a fourth configuration, the configuration is such that: In one of sustain electrodes 6, the detached parts of the first and second parts are respectively disposed at the same position in the extension direction of display electrodes 7. In sustain electrode 6 adjacent to the one, the detached parts of the first and second parts are respectively disposed at the same position in the extension direction of sustain electrodes 6. However, the detached parts in the one of sustain electrodes 6 are disposed at different position from the detached parts in sustain electrode 6 adjacent to the one, in the extension direction of sustain electrodes 6. Therefore, the boundary between scan electrodes 5 and the floating electrodes is visually unclear.

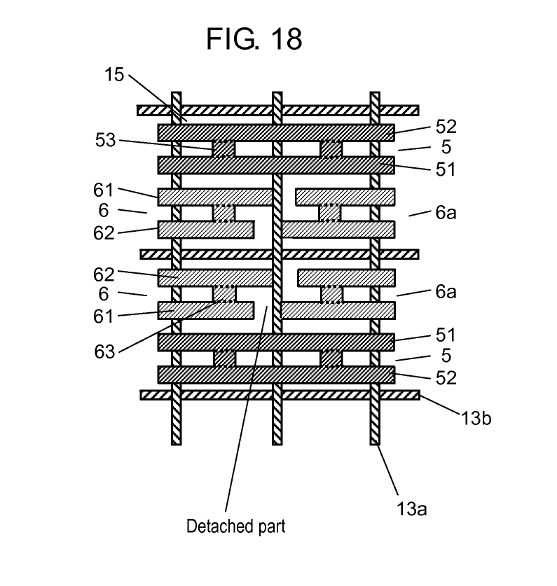

As shown in FIG. 18, as a fifth configuration, the configuration is such that: In one of sustain electrodes 6, the detached part of first part 61 and the detached part of second part 62 are disposed at different positions from each other in the extension direction of sustain electrodes 6. In sustain electrode 6 adjacent to the one, the detached part of first part 61 and the detached part of second part 62 are disposed at different positions from each other in the extension direction of sustain electrodes 6. Therefore, the boundary between scan electrodes 5 and the floating electrodes is visually unclear.

Another configuration is such that, in non-picture part B, the structures of scan electrodes 5 and floating sustain electrodes 6a are modified such that the reflectance difference is set to be within 5% between the effective display region and non-picture part B. Non-picture part B where barrier ribs 13 are not disposed exhibits a lower reflectance. For this reason, the area of floating sustain electrodes 6a is preferably reduced to 75% of the area in the effective display region. A way for reducing the area includes, for example, reducing the electrode widths of scan electrodes 5 and floating sustain electrodes 6a, and changing the configuration of third parts 63 from being disposed for every one cell to being disposed for every two cells. With this configuration, the reflectance difference between the effective display region and non-picture part B becomes smaller. As a result, something strange is hard to be felt in the display screen of PDP 21.

### 7. Summary of Embodiments

Hereinafter, characteristic parts of the aforementioned embodiments will be listed and described. Note, however, that the aspects, included in the aforementioned embodiments, of the present invention are not limited to those described below.

(1)

PDP21 disclosed herein includes an effective display region, and a non-display region disposed outside the effective display region. Moreover, PDP 21 includes rear plate 2, and front plate 1 disposed to face the rear plate 2. Front plate 1 includes sustain electrodes 6 and scan electrodes 5, over a region corresponding to the effective display region and over a region corresponding to the non-display region. Each of the sustain electrodes 6 includes first part 61, second part 62 disposed away from first part 61, and third parts 63 that electrically couple first part 61 with second part 62. Moreover, each of the sustain electrodes 6 includes a detached part in each of first part 61 and second part 62, in the region corresponding to the non-display region. Each of the detached parts included in one of sustain electrodes 6 is disposed at a different position in the extension direction of sustain electrodes 6.

With this configuration, the detached parts are hard to be visually recognized, which improves the display quality in the non-display region. Consequently, it is possible to provide PDP 21 having a narrower outer frame part.

(2)

PDP21 disclosed herein includes an effective display region, and a non-display region disposed outside the effective display region. Moreover, PDP 21 includes rear plate 2, and front plate 1 disposed to face the rear plate 2. Front plate 1 includes sustain electrodes 6 and scan electrodes 5, over a region corresponding to the effective display region and over a region corresponding to the non-display region. Each of the sustain electrodes 6 includes first part 61, second part 62 disposed away from first part 61, and third parts 63 that electrically couple first part 61 with second part 62. Moreover, each of the sustain electrodes 6 includes a detached part in each of first part 61 and second part 62, in the region corresponding to the non-display region. Each of the detached parts included in one of the sustain electrodes 6 and the detached parts in a sustain electrode 6 adjacent to the one of the sustain electrodes 6 are disposed at different positions in an extension direction of the sustain electrodes 6.

With this configuration, the detached parts are hard to be visually recognized, which improves the display quality in the non-display region. Consequently, it is possible to provide PDP 21 having a narrower outer frame part.

(3)

In the PDP described in (1) or (2), the detached parts are each not smaller than 90 μm and not larger than 100 μm.

This allows the detached parts to be made narrower, which results in a less visual recognition of the boundary between the detached parts and the other ones, providing PDP 21 with high display quality.

(4)

In PDP 21 described in (1) or (2), the plurality of sustain electrodes 6 include first sustain electrodes 601, and second sustain electrodes 602 adjacent to first sustain electrodes 601. Second parts 62 of first sustain electrodes 601 are located respectively adjacent to second parts 62 of second sustain electrodes 602. The plurality of the sustain electrodes further include fourth parts 64 that respectively couple second parts 62 of first sustain electrodes 601 with second parts 62 of second sustain electrodes 602.

This allows compensation for the area of the detached parts, which results in a less visual recognition of the detached parts, providing PDP 21 with high display quality.

(5)

In PDP 21 described in (4), the area of each of fourth parts 64 is smaller than the sum of the area of the detached parts of first sustain electrode 601 and the area of the detached parts of second sustain electrode 602, with both electrodes being coupled with each other by the each of fourth parts 64.

With this configuration, it is possible to suppress an increase in blackness, which leads to easier visual recognition, attributed to the additional area due to further-included fourth parts 64. This allows PDP 21 with higher display quality.

(6)

In PDP 21 described in (4), the area of each of fourth parts 64 is equal to the sum of the area of the detached part of the second part of first sustain electrode 601 and the area of the detached part of the second part of second sustain electrode 602, with both electrodes being coupled with each other by the each of fourth parts 64.

With this configuration, the compensated area becomes equal to a preferable value. Accordingly, the boundary between the detached parts and the other parts becomes harder to be visually recognized, which allows PDP 21 with higher display quality.

(7)

In PDP 21 described in (1) or (2), rear plate 2 includes data electrodes 12 that intersect with sustain electrodes 6 and scan electrodes 5, in the region corresponding to the effective display region and the region corresponding to the non-display region. Cells 15 are respectively disposed in intersections where data electrodes 12 and sustain electrodes 6 and scan electrodes 5 cross each other. At least one of the detached parts included in one of sustain electrodes 6 is disposed, in the non-display region, at a position corresponding to one of the cells 15 closest to the effective display region.

This prevents erroneous discharges from occurring in the non-display region, allowing PDP 21 with high quality.

As described above, the descriptions of the embodiments have been made as examples of the technologies of the present disclosure. For that purpose, the accompanying drawings and the detailed descriptions have been presented.

Consequently, of the elements described in the accompanying drawings and the detailed descriptions, some elements not essential for solving problems are possibly involved in order to exemplify the technologies. It should not be asserted that those inessential elements are essential ones on the grounds of the inessential elements being described in the accompanying drawings and the detailed descriptions.

Moreover, it should be understood that the aforementioned embodiments are only to exemplify the technologies of the present disclosure. Consequently, various modifications and changes, substitutions, additions, and omissions may be made to the embodiments without departing from the scope of the appended claims or their equivalents.

### INDUSTRIAL APPLICABILITY

As described above, the technologies disclosed in the embodiments are usable for such as display devices with a large screen.

### REFERENCE MARKS IN THE DRAWINGS

1 front plate
2 rear plate
3 discharge space
4 front substrate
5 scan electrode
6 sustain electrode
6a floating sustain electrode
601 first sustain electrode
602 second sustain electrode
7 display electrode
8 dielectric layer
9 protective layer
10 rear substrate
11 insulator layer
12 data electrode
13 barrier rib
13a vertical barrier rib
13b horizontal barrier rib
14R red phosphor layer
14G green phosphor layer
14B blue phosphor layer
15 cell
21 PDP
22 image signal processing circuit
23 data electrode drive circuit
24 scan electrode drive circuit
25 sustain electrode drive circuit
26 timing generation circuit
51, 61 first part
52, 62 second part
53, 63 third part
64 fourth part
100 plasma display device

1. A plasma display panel, comprising:
an effective display region;
a non-display region disposed outside the effective display region;
a rear plate; and
a front plate disposed to face the rear plate, the front plate including:
sustain electrodes and scan electrodes both disposed over a region corresponding to the effective display region and over a region corresponding to the non-display region,
each of the sustain electrodes includes a first part, a second part disposed away from the first part and third parts for electrically coupling the first part with the second part;
each of the sustain electrodes further includes a detached part in each of the first part and the second part, in the region corresponding to the non-display region; and
each of the detached parts included in one of the sustain electrodes is disposed at a different position in an extension direction of the sustain electrodes.

2. A plasma display panel, comprising:
an effective display region;
a non-display region disposed outside the effective display region;
a rear plate; and
a front plate disposed to face the rear plate, the front plate including:
sustain electrodes and scan electrodes both disposed over a region corresponding to the effective display region and over a region corresponding to the non-display region,
each of the sustain electrodes includes a first part, a second part disposed away from the first part and third parts for electrically coupling the first part with the second part;
each of the sustain electrodes further includes a detached part in each of the first part and the second part, in the region corresponding to the non-display region; and
each of the detached parts included in one of the sustain electrodes and the detached parts in a sustain electrode adjacent to the one of the sustain electrodes are disposed at different positions in an extension direction of the sustain electrodes.

3. The plasma display panel of claim 1, wherein the sustain electrodes include a first sustain electrode and a second sustain electrode adjacent to the first sustain electrode;
the second part in the first sustain electrode and the second part in the second sustain electrode are adjacent to each other; and
the sustain electrodes further include a fourth part for coupling the second part in the first sustain electrode with the second part in the second sustain electrode.

4. The plasma display panel of claim 3, wherein an area of the fourth part is smaller than a sum of an area of the detached parts included in the first sustain electrode and an area of the detached parts included in the second sustain electrode, the first sustain electrode and the second sustain electrode being coupled with each other by the fourth part.

5. The plasma display panel of claim 3, wherein an area of the fourth part is equal to a sum of an area of the detached part included in the second part in the first sustain electrode and an area of the detached part included in the second part in the second sustain electrode, the second part in the first sustain electrode and the second part in the second sustain electrode being coupled with each other by the fourth part.

6. The plasma display panel of claim 1, wherein the detached part is not smaller than 90 μm and not larger than 100 μm.

7. The plasma display panel of claim 1, wherein the rear plate includes electrodes in the region corresponding to the effective display region and in the region corresponding to the non-display region, the electrodes intersecting with the sustain electrodes and the scan electrodes;
cells are respectively disposed in intersections where the electrodes, the sustain electrodes and the scan electrodes cross each other; and
at least the detached parts included in the one of the sustain electrodes is disposed, in the non-display region, at a position corresponding to one of the cells, the one being closest to the effective display region.

8. The plasma display panel of claim 2, wherein the sustain electrodes include a first sustain electrode and a second sustain electrode adjacent to the first sustain electrode;
the second part in the first sustain electrode and the second part in the second sustain electrode are adjacent to each other; and
the sustain electrodes further include a fourth part for coupling the second part in the first sustain electrode with the second part in the second sustain electrode.

9. The plasma display panel of claim 8, wherein an area of the fourth part is smaller than a sum of an area of the detached parts included in the first sustain electrode and an area of the detached parts included in the second sustain electrode, the first sustain electrode and the second sustain electrode being coupled with each other by the fourth part.

10. The plasma display panel of claim 8, wherein an area of the fourth part is equal to a sum of an area of the detached part included in the second part in the first sustain electrode and an area of the detached part included in the second part in the second sustain electrode, the second part in the first sustain electrode and the second part in the second sustain electrode being coupled with each other by the fourth part.

11. The plasma display panel of claim 2, wherein the detached part is not smaller than 90 μm and not larger than 100 μm.
